(19) United States
(12) Patent Application Publication
(10) Pub. No.: US 2004/0009324 A1
(43) Pub. Date: Jan. 15, 2004

(54) Waterproof strip formed with liquid material

(76) Inventor: Chin Wang Wu, Yuan Shan Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,068

(22) Filed: Jul. 10, 2002

(51) Int. Cl. B32B 3/00

(52) U.S. Cl. 428/102; 428/61

(57) ABSTRACT

A waterproof strip for sealing a joint between waterproof sheets is disclosed. The waterproof strip includes (1) a first material comprising a mixture of 50%-70% polyurethane and 20%-30% aromatic and a thinner for controlling a viscosity of the first material between 350,000-950,000 cps and (2) a second material comprising a mixture of 70%-90% polyurethane, 5%-15% silicone and 5%-15% lubricant and a thinner for controlling a viscosity of the second material below 7,000 cps. Both the first and second materials are in liquid form and can be applied by a pressurized coating equipment to the joint between the waterproof sheets. The first material is applied on the joint between the waterproof sheets first to allow the first material to penetrate into the joint. After the first material cures, the second material is applied on the first material and integrally combines with the first material to form a unitary strip. A dying material is selectively added into the first material to obtain a desired color.

### BACKGROUND OF THE INVENTION

1. Field of the Invention

The present invention generally relates to a waterproof strip for sealing joint between two waterproof sheets, and in particular to such a waterproof strip formed with liquid materials.

2. The Related Art

Waterproof wears are commonly used in water sports, such as diving, surfing and canoeing. The waterproof wears that are used in water sports must have the characteristics of lightweight, elasticity, buoyancy, being easy to put on and take off and tactual comfort of skin contact in order to allow the wearer to keep warm and to move without substantial constraints. The most commonly used material is foamed rubber.

Some waterproof wears are made by jointing separate sheets of waterproof material together. The joint is formed by sewing and/or adhesives. The sewing operation causes deficiency of waterproofness in long-term use of the waterproof wears, as well as irritation to the wearer's skin. Conventionally, the waterproofness between two jointed waterproof sheets is accomplished by attaching a solid pad of waterproof strip to the joint. An example of the solid waterproof pad is a heat-meltable adhesive material. The adhesive material can be melted first and then coated to a piece of waterproof material. The piece of waterproof material is then cut to the desired size. The piece of waterproof material can be attached to the joint by heating and thus melting the adhesive that is coated on the waterproof material. By application of pressure, the piece of waterproof material is attached to and seals the joint.

Another conventional way is to form a film of an adhesive material. Such a film is then subject to heat and pressure to mount to a piece of waterproof material. Such a piece of waterproof material with the adhesive film mounted thereto is then cut to the desired size for further use.

Such conventional manners cannot be adopted in foamed waterproof wears because the foam material cannot take the high temperature in handling the adhesive materials. Besides, the adhesive pad that is employed in the prior art techniques cannot effectively penetrate into the joint of the waterproof wear when it is heated and partly melted. Thus, the pad may get separated from the waterproof wears in long-term use. Furthermore, such conventional manner cannot overcome the deficiency of irritating the wearer's skin by the sewing.

### SUMMARY OF THE INVENTION

Thus, an object of the present invention is to provide a waterproof strip for sealing a joint of foamed waterproof sheets.

Another object of the present invention is to provide a waterproof strip for sealing a sewing joint between waterproof sheets and providing excellent tactual comfort to a wearer's skin.

A further object of the present invention is to provide a waterproof strip that forms a durable sealing for a sewing joint between waterproof sheets.

To achieve the above objects, in accordance with the present invention, there is provided a waterproof strip for sealing a joint between waterproof sheets. The waterproof strip comprises (1) a first material comprising a mixture of 50%-70% polyurethane and 20%-30% aromatic and a thinner for controlling a viscosity of the first material between 350,000-950,000 cps and (2) a second material comprising a mixture of 70%-90% polyurethane, 5%-15% silicone and 5%-15% lubricant and a thinner for controlling a viscosity of the second material below 7,000 cps. Both the first and second materials are in liquid form and can be applied by a pressurized coating equipment to the joint between the waterproof sheets. The first material is applied on the joint between the waterproof sheets first to allow the first material to penetrate into the joint. After the first material cures, the second material is applied on the first material and integrally combines with the first material to form a unitary strip. A dying material is selectively added into the first material to obtain a desired color. If desired, a surface-treating agent can be applied on the waterproof sheets first and the first material is applied over the surface treating agent.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view showing a waterproof strip in accordance with the present invention being formed by coating liquid materials to a waterproof wear;

FIG. 2 is a schematic view showing a waterproof strip in accordance with the present invention for sealing a sewing joint between waterproof sheets that make a waterproof wear;

FIG. 3 is a cross-sectional view showing the waterproof strip of the present invention embodied in a waterproof wear that is used in a low pressure environment; and

FIG. 4 is a cross-sectional view showing the waterproof strip of the present invention embodiment in a waterproof wear that is used in a high-pressure environment.

### DETAILED DESCRIPTION OF THE PREFERRED EMBODIMENTS

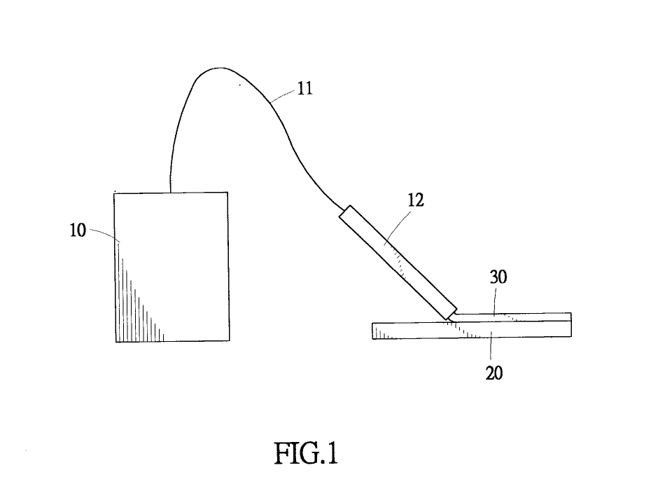

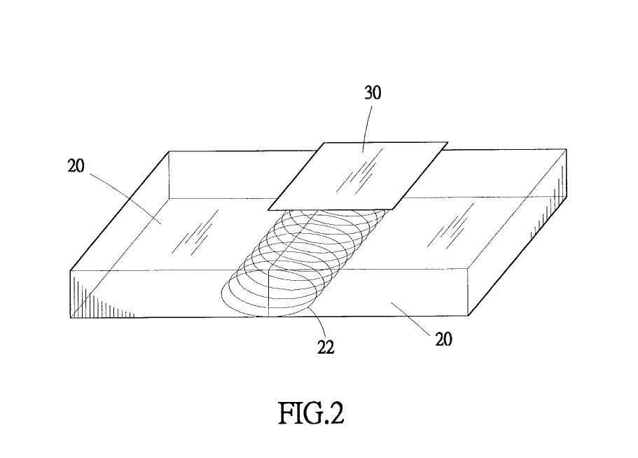

With reference to the drawings and in particular to FIGS. 1 and 2, a waterproof strip in accordance with the present invention, generally designated with reference numeral 30, is coated on waterproof sheets, such as a foamed sheet, and/or to seal a sewing joint between two waterproof sheets. The waterproof sheets are generally designated with reference numeral 20 in FIGS. 1 and 2. Reference numeral 22 in FIG. 2 indicates sewing threads that joint the two waterproof sheets 20.

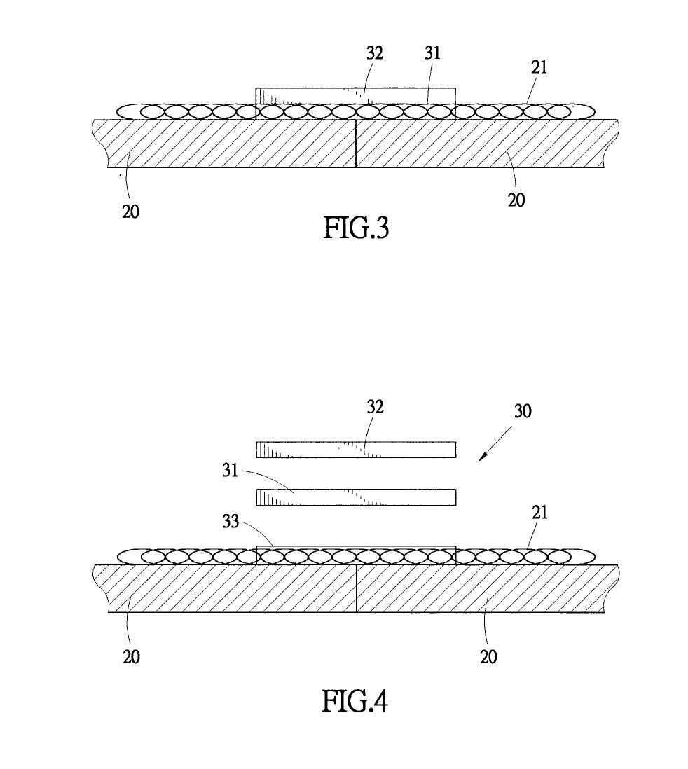

In accordance with the present invention, the waterproof strip 30 is formed with liquid materials, which comprise a first material 31 and a second material 32 (see FIGS. 3 and 4). The first material 31 is made of the following components:

50%-70% polyurethane, and

20%-30% aromatic

The components are put and fully mixed in a tank. A thinner is added in the mixture to control the viscosity of the mixture between 350,000-950,000 cps. The viscosity of the mixture is controlled by adding different amount of thinner in the mixture. The determination of the viscosity is based on the penetration of the mixture into the waterproof sheets 20.

If desired, a dying material or pigment can be added in the mixture to obtain a desired color of the first material 31 of the waterproof strip 30. The color can be selected to match that of the waterproof sheets 20.

The second material 32 comprises the following components:

70%-90% polyurethane,

5%-15% silicone, and

5%-15% lubricant.

The above components are put and fully mixed in a tank and combined with a thinner to have a viscosity below 7,000 cps for the second material 32. Due to the existence of silicone and the lubricant, the second material 32 has excellent lubrication characteristics.

The waterproof strip 30 of the present invention is applied to a joint between two waterproof sheets 20 as shown in FIG. 2. The application is accomplished by uniformly coating the first material 31 that is liquid on and over the joint between the waterproof sheets 20 and allowing the first material 31 to penetrate into the joint and the sewing threads 22. The first material 31 is then allowed to cure and solidify and thereafter the second material 32 that is liquid too is uniformly applied on the first material 31. A unitary waterproof strip is thus obtained after the second material 32 cures and solidifies and integrally combine with the first material 31. Such a waterproof strip retains excellent elasticity and is easy to put on and take off after a long-term use. Two examples will be discussed.

Example 1 is shown in FIG. 3. The application of the waterproof strip is done by means of the coating equipment shown in FIG. 1. The first material 31 is formed and controlled to have a viscosity of 750,000 cps. The first material 31 is deposited in a pressurizing tank 10 of the coating equipment and delivered through a line 11 to a coating gun 12 which allows uniform coating of the first material 31 on the joint of the waterproof sheets 20. The gun 12 can be properly modified to apply the material in any desired amount and manner whereby the width and thickness of the materials coated on the waterproof sheets can be well controlled. The first material 31 penetrates into a fabric 21 that contains the sewing threads 22. When the first material 31 cures, it forms a thin film in the fabric 21. The second material 32 that is made to have a viscosity of 5,000 cps is deposited in the tank 10 and applied on the film of the first material 31 by the gun 12. The second material 32 integrally combines with the first material 31 and forms a unitary strip after the second material 32 cures. Such a strip has excellent elasticity and tactual comfort.

The application shown in FIG. 3 (Example 1) is suitable for waterproof wears used in a low-pressure environment, such as surfing and other water surface activities.

Example 2 is shown in FIG. 4. A surface-treating agent 33 is first applied over the joint between the waterproof sheets 20. The coating equipment is then employed to apply the first material 31 having a viscosity of 750,000 cps over the surface-treating agent 33. Due to the surface-treating agent 33, the first material 31 is allowed to penetrate into a fabric 21 containing the sewing threads 22 and integrally combines therewith. After the first material 31 cures, the second material 32 having a viscosity of 5,000 cps is uniformly applied on the first material 31 by the coating equipment. The second material 32 integrally combines with the first material 31 and forms a unitary strip after the second material 32 cures. Such a strip has excellent elasticity and tactual comfort.

The application shown in FIG. 4 (Example 2) is suitable for waterproof wears used in a high-pressure environment, such as diving.

Since the second material 32 comprises a lubricant therein, an excellent lubrication and separation characteristics can be obtained and can have excellent elasticity and tactual comfort.

If desired, the second material 32 can be applied to any additionally processed portion of a waterproof wear by means of for example a brush. This can reduce the irritation of such portion on the wearer's skin and allows the waterproof wear to be easier to put on and take off and enhance the tactual comfort of wearing the waterproof wear.

To this point, it is understood that the present invention is characterized in that:

(1) Waterproof strip formed with liquid materials: The liquid materials (first and second materials 31, 32) of the strip 30 can be of selectable viscosity that allows the strip 30 to penetrate into and integrally combines with the joint between waterproof sheets. A durable waterproofness can be obtained between the waterproof sheets and also excellent elasticity and tactual comfort.

(2) Penetrability: The liquid materials 31, 32 of the strip 30 can penetrate into the joint and the sewing portion to integrally combine with the waterproof sheets.

(3) Lubrication: The second material 32 comprises a lubricant which provides the strip 30 with an excellent lubrication with a wearer's skin thereby reducing the resistance between the wearer's skin and the waterproof wear and enhancing tactual comfort of the wearer's skin.

(4) Elasticity: The waterproof strip 30 has an excellent elasticity and thus does not impose any additional constraint to the waterproof sheet.

(5) Colorfulness: The materials 31, 32 of the waterproof strip 30 can be selectively added with dying material or pigment to obtain a desired color.

(6) Versatility in size: The waterproof strip can be formed with different width and thickness by adjusting and/or redesigning the coating gun of the coating equipment thereby being suitable for different waterproof wears and products.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A waterproof strip adapted to seal joint between waterproof sheets, the waterproof strip comprising:
a first material comprising a mixture of 50%-70% polyurethane and 20%-30% aromatic and a thinner for controlling a viscosity of the first material between 350,000-950,000 cps;
a second material comprising a mixture of 70%-90% polyurethane, 5%-15% silicone and 5%-15% lubricant and a thinner for controlling a viscosity of the second material below 7,000 cps;
wherein the first material is applied on the joint between the waterproof sheets first to allow the first material to penetrate into the joint and wherein after the first material cures, the second material is applied on the first material and integrally combines with the first material to form a unitary strip.

2. The waterproof strip as claimed in claim 1, wherein the first material is selectively added with a dying material to provide a color.

3. The waterproof strip as claimed in claim 1, wherein the joint between the waterproof sheets is formed by sewing and wherein the first material is allowed to penetrate into the sewing portion of the waterproof sheets.

4. The waterproof strip as claimed in claim 1, wherein the first material has a viscosity of 750,000 cps and is applied to the joint of the waterproof sheets and penetrates into the joint and wherein the second material has a viscosity of 5,000 cps and is applied on the first material to integrally combine with the first material and forms a unitary strip.

5. The waterproof strip as claimed in claim 1 further comprising a surface treating agent applied over the joint of the waterproof sheets first and wherein the first material is applied on the surface-treating agent.

6. The waterproof strip as claimed in claim 5, wherein the first material has a viscosity of 750,000 cps and penetrates into the joint and wherein the second material has a viscosity of 5,000 cps and is applied on the first material to integrally combine with the first material and forms a unitary strip.
